(19) United States
(12) Patent Application Publication
(10) Pub. No.: US 2020/0130553 A1
(43) Pub. Date: Apr. 30, 2020

(54) CARPET FOR SOUND REDUCTION MATERIAL

(71) Applicant: SEOYON E-HWA CO., LTD., Seoul (KR)

(72) Inventor: Hyun Joon PARK, Seoul (KR)

(21) Appl. No.: 16/450,017

(22) Filed: Jun. 24, 2019

(30) Foreign Application Priority Data
Oct. 29, 2018 (KR) 10-2018-0129995

(51) Int. Cl. B60N 3/04; D06N 7/00

(52) U.S. Cl. CPC B60N 3/048; B32B 5/022; D06N 7/0081; D06N 7/0073

(57) ABSTRACT

A carpet for a sound reduction material is disclosed including: a non-permeable primary coating layer formed of polyethylene (PE) resin, being in contact with a lower surface of a fabric layer and having a basis weight of 200 to 300 g/m²; a permeable felt layer in contact with a lower surface of the primary coating layer and having a basis weight of 200 to 500 g/m²; and a non-permeable secondary coating layer formed of polyethylene (PE) resin or ethylene vinyl acetate (EVA), being in contact with a lower surface of the felt layer and having a basis weight of 200 to 1,000 g/m². The carpet for a sound reduction material may thus have improved noise, vibration and harshness (NVH) performance, reduced total weight and improved stiffness.

### CROSS-REFERENCE TO RELATED APPLICATION

This application claims priority to Korean Patent Application No. 10-2018-0129995, filed on Oct. 29, 2018, the disclosure of which is incorporated herein by reference in its entirety.

### BACKGROUND OF THE DISCLOSURE

### Field of the Disclosure

Exemplary embodiments in the present disclosure relate to a carpet for a sound reduction material having improved noise, vibration and harshness (NVH) performance, reduced weight and improved stiffness.

### Description of the Related Art

A sound reduction material refers to a material serving to reduce a sound. A vehicle carpet for a sound reduction material in a vehicle may be an interior material installed on a floor panel or a floor of a luggage compartment in the vehicle to keep a quiet interior atmosphere by blocking various noises such as engine noise, etc. occurring when the vehicle is running.

Such a vehicle carpet usually includes three layers, i.e. a fabric layer, a polyethylene (PE) coating layer and an ethylene vinyl acetate (EVA) coating layer.

Noise in the vehicle is a mixture of engine noise, wind noise and road noise. Noise performance is thus continuously required to be improved and a related technology has been developed. The present disclosure relates to a vehicle carpet in which sound reduction performance is improved to reduce the road noise among the above noises.

As a prior art related to a carpet for the sound reduction material, 1) Korean Patent No. 101905958 (Oct. 1, 2018) introduces a manufacturing method of a sound reduction material including: preparing a resin composition, which prepares a composite resin composition further including 50 parts by weight of aluminum oxide, 15 parts by weight of nanoclay, 0.2 parts by weight to 0.8 parts by weight of an antioxidant, 0.1 parts by weight to 0.5 parts by weight of a lubricant and 30 parts by weight of barium sulfate, with respect to 100 parts by weight of a base resin including a polyethylene (PE); and extrusion molding, which extrusion molds the composite resin composition prepared in the preparing of a resin composition. As another prior art related thereto, 2) Korean Patent No. 101033395 (Apr. 28, 2011) introduces a triple acoustic absorber for a vehicle, including a low melting point fiber (LMF) and a super fiber (SF) having a high melting point, the LMF and SF having different apparent densities from each other. The triple acoustic absorber for a vehicle includes a low density acoustic absorber, a high density acoustic absorber disposed at 30 to 100% of the area of the low density acoustic absorber, and a non-permeable layer formed of a rubber or resin material and disposed at 10 to 90% of the area of the low density acoustic absorber, in which the low density acoustic absorber is disposed so that one surface thereof is in contact with noise occurrence portion.

However, in order to reduce the noise in a vehicle, a heavy sound reduction material is often used for a polyethylene (PE) coating layer coated on a carpet fabric layer and an ethylene vinyl acetate (EVA) coating layer. In this case, a function as the sound reduction material is increased, but a weight of a vehicle body is increased, and thus fuel efficiency is lowered.

### RELATED ART DOCUMENT

### Patent Document

(Patent Document 1) Korean Patent No. 101905958 (Oct. 1, 2018)

(Patent Document 2) Korean Patent No. 101033395 (Apr. 28, 2011)

### SUMMARY OF THE DISCLOSURE

An object of the present disclosure is to provide a carpet for a sound reduction material having improved noise, vibration and harshness (hereinafter, NVH) performance, reduced total weight and improved stiffness by adding a felt layer between primary and secondary coating layers, and by setting an optimum weight ratio of a combined weight of the fabric layer and the primary coating layer to a weight of the secondary coating layer for minimizing a region with decreased sound reduction performance, and thus improving the NVH performance.

Other objects and advantages of the present disclosure may be understood by the following description, and become apparent with reference to the embodiments in the present disclosure. Also, it is obvious to those skilled in the art to which the present disclosure pertains that the objects and advantages of the present disclosure may be realized by the means as claimed and combinations thereof.

In accordance with an aspect of the present disclosure, a carpet for a sound reduction material may include: a fabric layer including a fibrous material; a non-permeable primary coating layer in contact with a lower surface of the fabric layer; a permeable felt layer in contact with a lower surface of the primary coating layer; and a non-permeable secondary coating layer in contact with a lower surface of the felt layer.

The fabric layer may be formed by coating latex on a polyester (PET) fiber or a polyamide (PA) fiber.

The primary coating layer may include olefin-based resin or vinyl-based resin.

The secondary coating layer may include olefin-based resin, a vinyl-based resin or ethylene vinyl acetate (EVA).

The felt layer may include a needle-punched polyester (PET) felt or a recycled fiber felt.

The felt layer may include a vertical lap type felt in which fibers are arranged in a vertical direction.

The felt layer may have a thickness of 1 mm to 5 mm.

The primary coating layer may have a basis weight of 200 to 300 g/m², the felt layer may have a basis weight of 200 to 500 g/m² and the secondary coating layer may have a basis weight of 200 to 1,000 g/m².

A weight ratio of a combined weight of the fabric layer and the primary coating layer to a weight of the secondary coating layer may be in a range of 1.31:1 to 4.0:1.

### BRIEF DESCRIPTION OF THE DRAWINGS

The above and other objects, features and other advantages of the present disclosure may be more clearly understood from the following detailed description taken in conjunction with the accompanying drawings, in which:

FIGS. 1A and 1B are views respectively showing a structure of a conventional carpet for a sound reduction material and that of a carpet for a sound reduction material according to an embodiment in the present disclosure;

FIG. 2 shows graphs illustrating a result comparing a noise transmission loss ratio in the structure of the conventional carpet for a sound reduction material and that in the structure of the carpet for a sound reduction material according to an embodiment in the present disclosure; and

FIG. 3 shows graphs illustrating that a region with decreased sound reduction performance occurs depending on a weight ratio between coating layers.

### DESCRIPTION OF SPECIFIC EMBODIMENTS

According to an embodiment in the present disclosure, a carpet for a sound reduction material is hereinafter described in detail with reference to the accompanying drawings.

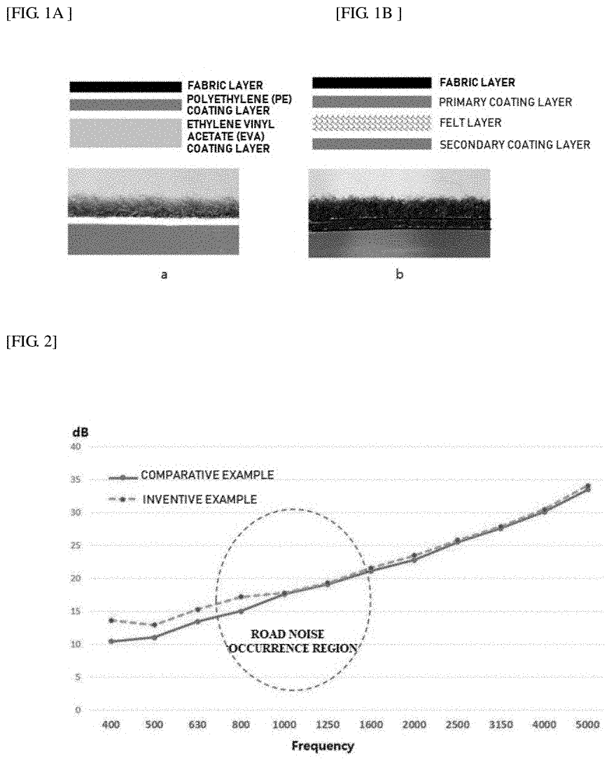

FIG. 1A is a view showing a structure of a conventional carpet for a sound reduction material in a vehicle, and FIG. 1B is a view showing a structure of a carpet for a sound reduction material in the present disclosure.

The conventional carpet for a sound reduction material may include a fabric layer, a polyethylene (PE) coating layer and an ethylene vinyl acetate (EVA) coating layer, and has an increased sound reduction effect by increasing the weight thereof.

The carpet for a sound reduction material in the present disclosure may be formed by sequentially stacking a primary coating layer in contact with a fabric layer, a felt layer and a secondary coating layer. In this way, the carpet for a sound reduction material in the present disclosure may have a sandwich structure by adding the felt layer between the primary and secondary coating layers, and thus have an effect of improved stiffness.

The fabric layer in the present disclosure may be formed by coating latex on a polyester (PET) fiber or a polyamide (PA) fiber.

The polyester (PET) fiber is one of common synthetic fibers, and synthesized from a low molecular weight compound and made of a synthetic polymer polymerized by a chemical method.

The polyamides may mainly include an amino acid, a lactam or a diamine and a dicarboxylic acid.

The primary coating layer may include at least one selected from olefin-based resin and vinyl-based resin.

The primary coating layer may include elastomeric resin which is a thermoplastic interpolymer having elasticity such as rubber.

The primary coating layer may include polyethylene (PE) resin having high tensile strength.

Polyethylene refers to a polymer including more than 50% by weight of units derived from an ethylene monomer. This polymer may be a polyethylene homopolymer or a copolymer.

Typical types of the polyethylene as disclosed in a related art may be low density polyethylene (LDPE), linear low density polyethylene (LLDPE), medium density polyethylene (MDPE) and high density polyethylene (HDPE).

The primary coating layer may be formed to be non-permeable due to the sandwich structure.

The primary coating layer may have a weight per unit area, i.e. a basis weight of 200 to 300 g/m².

The felt layer may be formed between the primary coating layer and the secondary coating layer.

The felt layer may be formed to be permeable.

The felt layer may include a felt made of a high-stiff and thick fabric obtained by compressing wool or fur.

The felt layer may include a felt selected from a needle-punched polyester (PET) felt or a recycled fiber felt.

The felt layer may also include a vertical lap type felt in which fibers are arranged in a vertical direction. A conventional polyester (PET) felt layer, in which fibers are arranged in a transverse direction, has a low rebound property and weakness against pressure from upper and lower layers. However, the felt layer in the present disclosure, in which the fibers are arranged in the vertical direction, has an improved rebound property, high strength against pressure from upper and lower layers, a low density, and a high ventilation property.

The felt layer may have a thickness of 1 mm to 5 mm.

The felt layer may have a weight per unit area, i.e. a basis weight of 200 to 500 g/m².

The secondary coating layer may include at least one selected from olefin-based resin, a vinyl-based resin and ethylene vinyl acetate (EVA).

The secondary coating layer may include elastomeric resin which is a thermoplastic interpolymer having elasticity such as rubber.

The secondary coating layer may include polyethylene (PE) resin having high tensile strength.

The secondary coating layer may be formed to be non-permeable.

The secondary coating layer may have a weight per unit area, i.e. a basis weight of 200 to 1,000 g/m².

Unlike the conventional carpet for a sound reduction material, which improves a sound reduction effect by simply using a method of increasing weights of the polyethylene (PE) coating layer and the ethylene vinyl acetate (EVA) coating layer, the carpet for a sound reduction material in the present disclosure may include the primary coating layer, the permeable felt layer, and the secondary coating layer to have an effect of an improved noise, vibration and harshness (hereinafter, NVH) performance by improving sound reduction performance, compared to the conventional carpet for a sound reduction material having the same weight.

A weight ratio of a combined weight of the fabric layer and the primary coating layer to a weight of the secondary coating layer is varied to confirm an optimum weight ratio for minimizing a region with decreased sound reduction performance. As a result, the region with decreased sound reduction performance occurs in a band of 3 to 6 KHz, and 1.31:1 to 4.0:1 is confirmed to be the optimum weight ratio range for minimizing the region with decreased sound reduction performance.

In more detail, 2.12:1 to 3.69:1 may be the optimum weight ratio range of a combined weight of the fabric layer and the primary coating layer to a weight of the secondary coating layer.

By setting the optimum weight ratio for improving the NVH performance, the carpet for a sound reduction material in the present disclosure may have a reduced total weight and cost.

Hereinafter, in order to confirm the effects of the present disclosure, exemplary embodiments are described in detail. However, the exemplary embodiments are illustratively provided to assist in understanding of the present disclosure, and therefore the technical scope of the present disclosure is not limited thereto.

### First Exemplary Embodiment

Each vehicle has a different frequency range where road noise occurs, but the road noise generally occurs in a range of 600 to 1,400 Hz.

In a first exemplary embodiment, performed is a comparison of a noise transmission loss ratio in a carpet according to a prior art (in FIG. 1A) and that in a carpet according to the present disclosure (FIG. 1B) to compare sound reduction effects of the two carpets under the same weight condition.

A comparative example includes a fabric layer, a polyethylene (PE) coating layer and an ethylene vinyl acetate (EVA) coating layer as shown in FIG. 1A.

Here, a total weight of the comparative example is set to have a basis weight of 1,400 g/m² including the fabric layer having a basis weight of 700 g/m², the polyethylene (PE) coating layer having a basis weight of 250 g/m² and the ethylene vinyl acetate (EVA) coating layer having a basis weight of 450 g/m².

An inventive example includes a fabric layer, a polyethylene (PE) primary coating layer, a polyester (PET) felt layer and a polyethylene (PE) secondary coating layer as shown in FIG. 1B.

Here, a total weight of the inventive example is set to have a basis weight of 1,400 g/m² including the fabric layer having a basis weight of 400 g/m², the polyethylene (PE) primary coating layer having a basis weight of 200 g/m², the polyester (PET) felt layer having a basis weight of 500 g/m² and the polyethylene (PE) secondary coating layer having a basis weight of 300 g/m².

Table 1 below shows each measured value of noise transmission loss ratio per frequency.

TABLE 1

| | | | | | | | | | | | | |
|---|---|---|---|---|---|---|---|---|---|---|---|---|
| Hz | 400 | 500 | 630 | 800 | 1000 | 1250 | 1600 | 2000 | 2500 | 3150 | 4000 | 5000 |
| Comparative | 10.4 | 11 | 13.4 | 15 | 17.6 | 19.1 | 21.1 | 22.8 | 25.5 | 27.6 | 30.1 | 33.5 |
| Example | | | | | | | | | | | | |
| Inventive | 13.6 | 12.9 | 15.3 | 17.2 | 17.8 | 19.3 | 21.6 | 23.5 | 25.8 | 27.9 | 30.5 | 34.1 |
| Example | | | | | | | | | | | | |

In order to measure the noise transmission loss ratio as above, performed is ISO 15186-1, i.e. a measurement of sound insulation in buildings and of building elements using sound intensity set by International Organization for Standardization.

As seen from FIG. 2, in the road noise occurrence region, the inventive example, i.e. the carpet for a sound reduction material according to the present disclosure has an improved noise transmission loss ratio as compared with the comparative example, i.e. the carpet for a sound reduction material according to the prior art.

### Second Exemplary Embodiment

In a second exemplary embodiment, a weight ratio of a combined weight of a fabric layer and a primary coating layer to a weight of a secondary coating layer in a carpet according to the present disclosure, is varied to confirm an optimum weight ratio for minimizing a region with decreased sound reduction performance, and thus improving noise, vibration and harshness (NVH) performance.

Table 2 shows a result of whether or not the region with decreased sound reduction performance occurs in a high frequency band depending on a weight ratio of a combined weight of the fabric layer and a polyethylene (PE) primary coating layer to a weight of a polyethylene (PE) secondary coating layer.

TABLE 2

| | | | | Weight Ratio (of Combined |
|---|---|---|---|---|
| Combined Basis | | Basis Weight | Sound Reduction | Weight of Fabric Layer and |
| Weight (g/m²) of | Basis Weight | (g/m²) of | Performance | Primary Coating Layer to |
| Fabric Layer and | (g/m²) of Felt | Secondary | Decrease in High | Weight of Secondary Coating |
| Primary Coating Layer | Layer | Coating Layer | Frequency Region | Layer) |
| 900 | 300 | 200 | ◯ | 4.50:1 |
| 800 | 300 | 200 | Δ | 4.00:1 |
| 737 | 500 | 200 | X | 3.69:1 |
| 1,100 | 400 | 350 | X | 3.14:1 |
| 687 | 500 | 250 | X | 2.75:1 |
| 1,150 | 500 | 450 | X | 2.56:1 |
| 637 | 500 | 300 | X | 2.12:1 |
| 1,050 | 400 | 800 | Δ | 1.31:1 |
| 637 | 500 | 550 | ◯ | 1.16:1 |
| 850 | 300 | 800 | ◯ | 1.06:1 |
| 637 | 500 | 700 | ◯ | 0.91:1 |

The region with decreased sound reduction performance occurs in a band range of 3 to 6 KHz depending on the weight ratio of a combined weight of the fabric layer and the primary coating layer to a weight of the secondary coating layer.

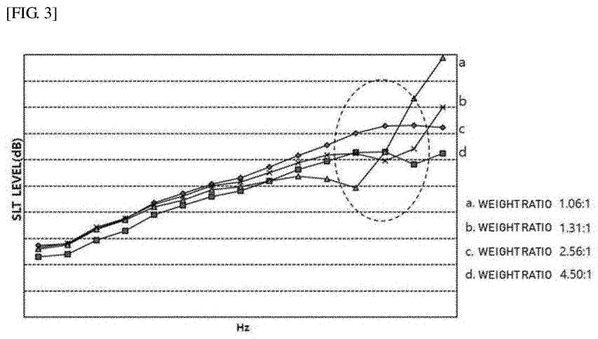

FIG. 3 shows graphs illustrating whether or not the region with decreased sound reduction performance occurs when a weight ratio of a combined weight of the fabric layer and the primary coating layer to a weight of the secondary coating layer is (a) 4.50:1, (b) 2.56:1, (c) 1.31:1 or (d) 1.06:1.

The region with decreased sound reduction performance occurs when the weight ratio is (a) 4.50:1, (c) 1.31:1 or (d) 1.06:1, but not when the weight ratio is (b) 2.56:1.

1.31:1 to 4.0:1 is a weight ratio range of a combined weight of the fabric layer and the primary coating layer to a weight of the secondary coating layer, which is excellent in minimizing the region with decreased sound reduction performance.

As described above, the carpet for a sound reduction material in the present disclosure may include the primary coating layer, the permeable felt layer, and the secondary coating layer to have an effect of the improved NVH performance compared to the conventional carpet for a sound reduction material having the same weight.

Further, the carpet for a sound reduction material in the present disclosure may confirm the optimum weight ratio for minimizing the region with decreased sound reduction performance which occurs in a high frequency band based on a weight ratio of a combined weight of the fabric layer and the primary coating layer to a weight of the secondary coating layer, and thus have improved NVH performance, reduced total weight and cost.

Furthermore, the carpet for a sound reduction material in the present disclosure may have a sandwich structure by adding the felt layer between the primary and secondary coating layers, and thus have the effect of improved stiffness.

The exemplary embodiments in the present disclosure described above and illustrated in the drawings should not be interpreted as limiting the technical idea of the present disclosure. The scope of the present disclosure is limited only by the accompanying claims, and those skilled in the art may modify and change the technical idea of the present disclosure in various forms. Therefore, it is obvious to those skilled in the art that these alterations and modifications fall within the scope of the present disclosure.

What is claimed is:

1. A carpet for a sound reduction material, comprising:
a fabric layer including a fibrous material;
a non-permeable primary coating layer in contact with a lower surface of the fabric layer;
a permeable felt layer in contact with a lower surface of the primary coating layer; and
a non-permeable secondary coating layer in contact with a lower surface of the felt layer.

2. The carpet for a sound reduction material of claim 1, wherein the fabric layer is formed by coating latex on a polyester (PET) fiber or a polyamide (PA) fiber.

3. The carpet for a sound reduction material of claim 1, wherein the primary coating layer includes olefin-based resin or vinyl-based resin.

4. The carpet for a sound reduction material of claim 1, wherein the secondary coating layer includes olefin-based resin, vinyl-based resin or ethylene vinyl acetate (EVA).

5. The carpet for a sound reduction material of claim 1, wherein the felt layer includes a needle-punched polyester (PET) felt or a recycled fiber felt.

6. The carpet for a sound reduction material of claim 5, wherein the felt layer includes a vertical lap type felt in which fibers are arranged in a vertical direction.

7. The carpet for a sound reduction material of claim 5, wherein the felt layer has a thickness of 1 mm to 5 mm.

8. The carpet for a sound reduction material of claim 1, wherein the primary coating layer has a basis weight of 200 to 300 g/m², the felt layer has a basis weight of 200 to 500 g/m² and the secondary coating layer has a basis weight of 200 to 1,000 g/m².

9. The carpet for a sound reduction material of claim 1, wherein a weight ratio of a combined weight of the fabric layer and the primary coating layer to a weight of the secondary coating layer is in a range of 1.31:1 to 4.0:1.
